(19) United States
(12) Patent Application Publication
(10) Pub. No.: US 2006/0072274 A1
(43) Pub. Date: Apr. 6, 2006

(54) Method of controlling surge current in fan modules and apparatus thereof

(76) Inventors: Jen-Hsuen Huang, Pate City (TW); Yang-Wen Su, Taipei City (TW)

Correspondence Address: RABIN & Berdo, PC, 1101 14TH STREET, NW, SUITE 500, WASHINGTON, DC, 20005, US

(21) Appl. No.: 11/107,789

(22) Filed: Apr. 18, 2005

(30) Foreign Application Priority Data
Oct. 1, 2004 (TW) 93129941

(51) Int. Cl. H02H 3/00

(52) U.S. Cl. 361/97

(57) ABSTRACT

A method of controlling surge current in fan modules is applied in a blade server. The blade server includes a fan module having a first fan motor, a second fan motor, a first resistor/capacitor (RC) circuit and a second RC circuit. The blade server generates a control signal for controlling the first and the second fan motors. The first RC circuit receives and delays the control signal for a period of first time to output a first delay control signal for driving the first fan motor. The second RC circuit receives and delays the control signal for a period of second time to output a second delay control signal for driving the second fan motor. The first time is different from the second time and thus the first surge current in the first fan motor and the second surge current in the second fan motor are generated at different time.

This application claims the benefit of Taiwan application Serial No. 93129941, filed Oct. 1, 2004, the subject matter of which is incorporated herein by reference.

### BACKGROUND OF THE INVENTION

1. Field of the Invention

The invention relates in general to a method of controlling surge current in fan modules and apparatus thereof, and more particularly to a method of controlling surge current in fan modules and apparatus thereof, applied in a blade server.

2. Description of the Related Art

Referring to FIG. 1, a block diagram of a fan module 110 in a conventional blade server 100 is shown. The blade server 100 generates a control signal FAN_ID as switched on, and the control signal FAN_ID is inputted to the first driver 102 and the second driver 106 to actuate the first fan motor 104 and the second fan motor 108 simultaneously.

However, at the time when the power is inputted to rotate the fan motors 104 and 108, surge currents will be generated. If there is more than one fan motor actuated simultaneously in the blade server 100, all the surge currents generated will accumulate in a certain region of the control circuit. The accumulating surge currents may reach several tenth times or even several hundred times of the surge current generated by a single fan motor. The large current mentioned above will shut down the power supply at a short time or reset all the main boards or function modules in the system or even cause error operations. All these will cause data in the blade server 100 got lost or the lift-time of the interior electronic components shortened or even broken, which is a very serious problem with regard to the blade server 100. Therefore, in order to solve the undue surge current issue, the circuit for controlling the actuation of fan motors is required.

In order to prevent the undue surge current issue, most of the present methods control fan motors to be actuated at different time by using control chips. However, these methods not only increase the cost and the design difficulty, but also enhance the loading of the manage platform in the blade server.

### SUMMARY OF THE INVENTION

It is therefore an object of the invention to provide a method of controlling surge current in fan modules and apparatus thereof, applied in a blade server. The invention can solve the issue of the undue accumulation of surge currents generated by several fan motors or fan modules actuated simultaneously.

The invention achieves the above-identified object by providing an apparatus for controlling surge current in fan modules applied in a blade server. The blade server includes the fan module. The fan module includes a first fan motor and a second fan motor. The blade server generates a control signal for controlling the first fan motor and the second fan motor. The apparatus includes a first delay device, a first driver, a second delay device, and a second driver. The first delay device is for receiving and delaying the control signal for a period of first time to output a first delay control signal. The first driver receives the first delay control signal for driving the first fan motor. The second delay device is for receiving and delaying the control signal for a period of second time to output a second delay control signal. The second driver receives the second delay control signal for driving the second fan motor. The first time is not equal to the second time, the first fan motor and the second fan motor respectively receive the first delay control signal and the second delay control signal at different time, and a first surge current in the first fan motor and thus a second surge current in the second fan motor are not generated at the same time.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 (Prior Art) is a block diagram of the fan module in a conventional blade server.

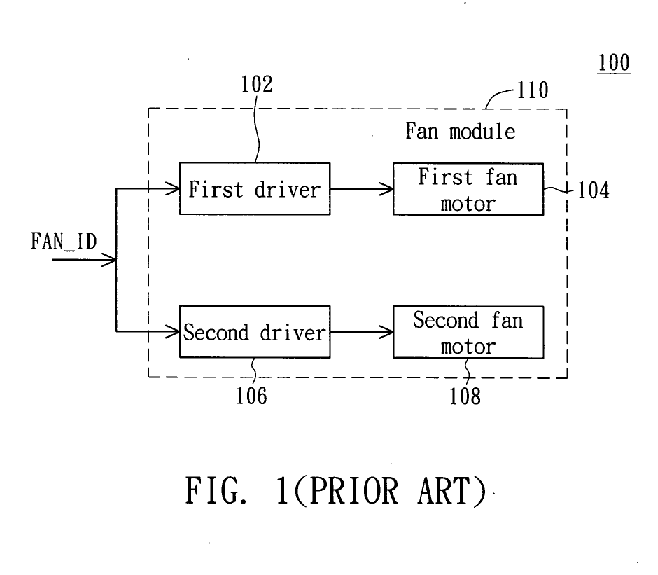

FIG. 2 is a block diagram of the apparatus for controlling surge current in fan modules according to a preferred embodiment of the invention.

FIG. 3 is a detailed circuit diagram of the apparatus for controlling surge current in fan modules in FIG. 2.

FIG. 4 is a block diagram of the apparatus for controlling surge current in fan modules according to another embodiment of the invention.

### DETAILED DESCRIPTION OF THE INVENTION

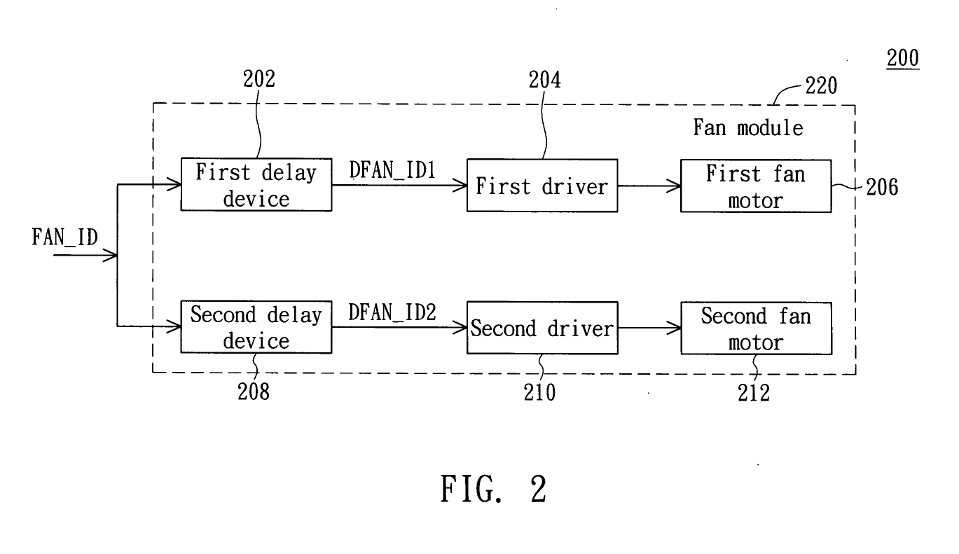

Referring to FIG. 2, a block diagram of the apparatus of controlling surge current in a fan module according to a preferred embodiment of the invention is shown. The apparatus of controlling surge current in the fan module 220 of the invention is applied in a blade server 200. The fan module 220 includes a first delay device 202, a first driver 204, a second delay device 208, a second driver 210, a first loading device and a second loading device. The first and the second loading devices are respectively for example, the first and the second fan motors 206 and 212 in the fan module 220.

The blade server 200 generates and transmits a control signal FAN_ID to the fan module 220. The first delay device 202 receives and delays the control signal FAN_ID for a period of first time t1 to output a first delay control signal DFAN_ID. The first driver 204 receives the first delay control signal DFAN_ID1 for driving the first fan motor 206. Similarly, the second delay device 208 receives and delays the control signal FAN_ID for a period of second time t2 to output the second delay control signal DFAN_ID2. The second driver 210 receives the second delay control signal DFAN_1D2 for driving the second fan motor 212. The first time t1 is not equal to the second time t2. Therefore, the first fan motor 206 and the second fan motor 212 respectively receive the first delay control signal DFAN_ID1 and the second delay control signal DFAN_ID2 at different time, and thus the first surge current in the first fan motor 206 and the second surge current in the second fan motor 212 will not be generated at the same time.

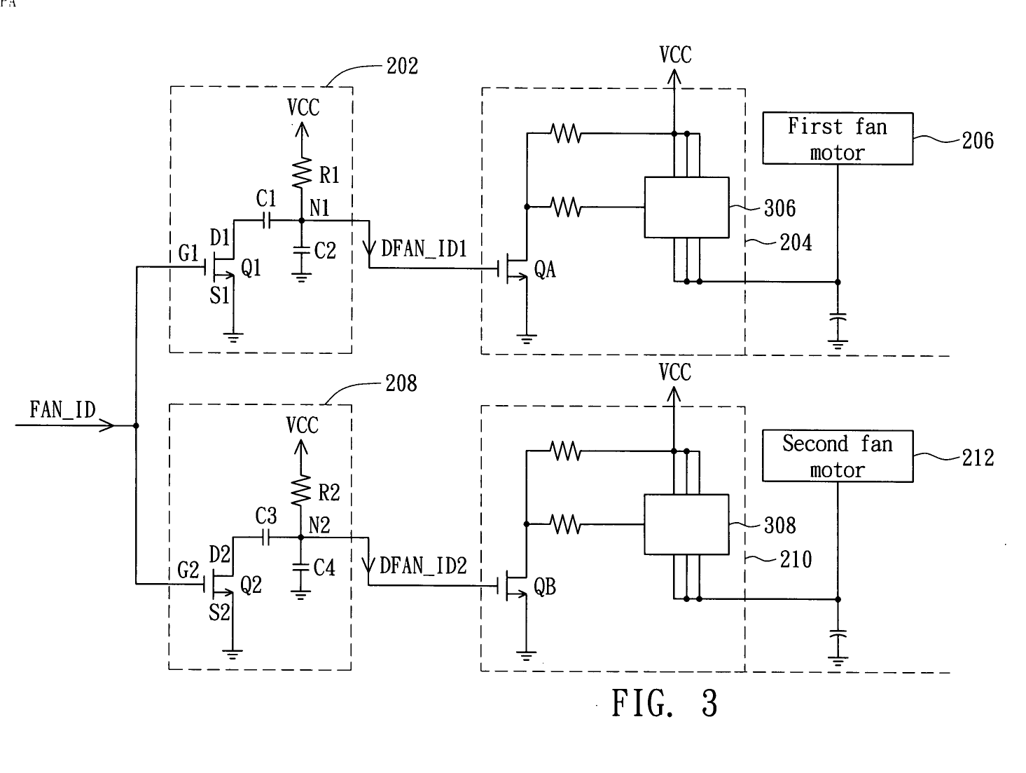

Furthermore, referring to FIG. 3, a detailed circuit diagram of the apparatus of controlling surge current in fan modules in FIG. 2 is shown. The first delay device 202 is a first resistor/capacitor (RC) circuit 202. The second delay device 208 is a second resistor/capacitor (RC) circuit 208. The spirit of the invention lies on generating different delay time t1 and t2 by designing the first RC circuit 202 and the second RC circuit 208 to have different time constants. The first RC circuit 202 has a first switch Q1, a first capacitor C1, a second capacitor C2 and a first impedance R1. The first switch has a first switch control terminal, a first terminal and a second terminal. For example, the first switch is a N-channel metal oxide semiconductor field effect transistor (MOSFET) Q1, the first switch control terminal is the gate G1 of the transistor Q1, the first terminal of the first switch is the drain D1 of the transistor Q1, and the second terminal of the first switch is the source S1 of the transistor Q1. The gate G1 receives the control signal FAN_ID, and the source S1 is coupled to a constant voltage, such as a ground voltage. The first impedance R1 is such as a resistor with a terminal coupled to a voltage source VCC and the other terminal coupled to the first node N1, which is coupled to the drain D1 via the first capacitor C1. The second capacitor C2 has one terminal coupled to the first node N1 and the other terminal coupled to the above-mentioned ground voltage. When the control signal is inputted to the first RC circuit 202, the first switch Q1 is turned on and the first delay control signal DFAN_ID1 is generated at the first node N1 after a period of first time t1 according to the time constant determined by the parameters R1, C1 and C2.

The second RC. circuit 208 includes a second switch Q2, a third capacitor C3, a fourth capacitor C4 and a second impedance R2. The second switch has a second switch control terminal, a first terminal and a second terminal. For example, the second switch is a N-channel MOSFET Q2, the second switch control terminal is the gate G2 of the transistor Q2, the first terminal of the second switch is the drain D2 of the transistor Q2, and the second terminal of the second switch is the source S2 of the transistor Q2. Since the second RC circuit 208 has same circuit structure and operation principle with the first RC circuit 202 except for the time constant, any detail of the second RC circuit is unnecessarily given here. When the control signal FAN_ID is inputted to the second RC circuit 208, the second switch is turned on and the second delay control signal DFAN_ID2 is generated at the second node N2 after a period of second time t2 according to the parameters R2, C3, and C4.

Moreover, the first driver 204 at least includes a transistor QA and a first power switch 306 while the second driver 210 includes a transistor QB and a second power switch 308. The first delay control signal DFAN_ID1 is for controlling the transistor QA while the second delay control signal DFAN_ID2 is for controlling the transistor QB. When the first delay control signal DFAN_ID1 is inputted to the first driver 204, the transistor QA is turned on and the first power switch 306 electrically coupled to the transistor QA is then switched on, and the first fan motor 206 starts to rotate as receiving the power supplied by the power source VDC. When the second delay control signal DFAN_ID2 is inputted to the second driver 210, the transistor QB is turned on and the second power switch 308 electrically coupled to the transistor QB is then switched on, and the second fan motor 208 starts to rotate as receiving the power supplied by the power source VDC.

As mentioned above, for the first RC circuit 202 has a different RC value from the second RC circuit 208, that is, the value (R1×C1) is unequal to the value (R2×C2), the delay time t1 of the first delay control signal DFAN_ID1 is different from the delay time t2 of the second delay control signal DFAN_ID2, and the power-on time of the transistors QA and QB is also different. Therefore, the actuating time of the first fan motor 206 differs from that of the second fan motor 210 and thus the first surge current in the first fan motor 206 and the second surge current in the second fan motor 212 are not generated at the same time.

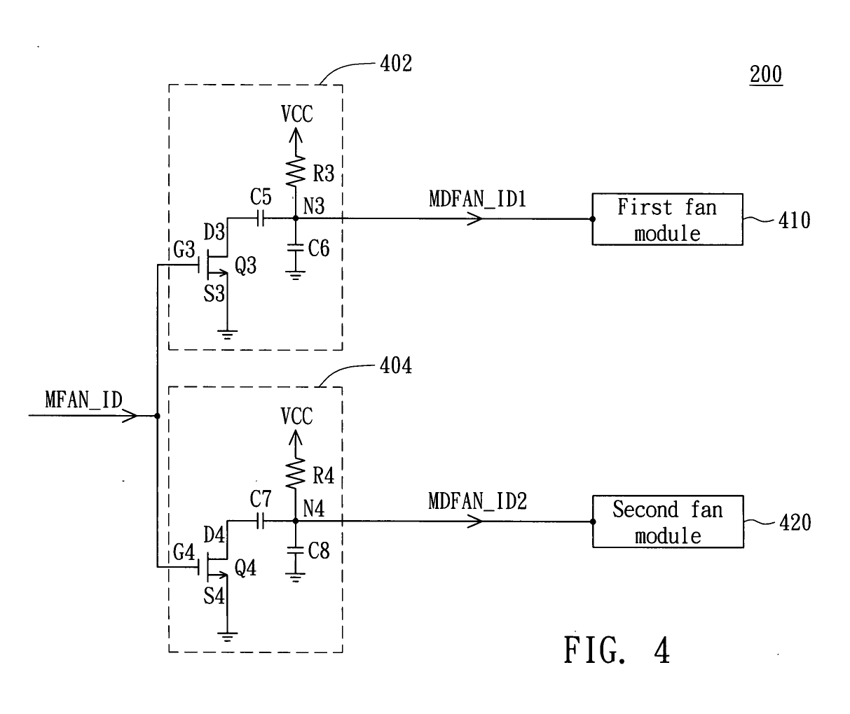

Referring to FIG. 4, a block diagram of the apparatus of controlling surge current in fan modules according to another embodiment of the invention is shown. The apparatus of the invention is applied in the blade server 200. The blade server 200 includes a first fan module 410, a second fan module 420, a first module RC circuit 402 and a second module RC circuit 404. The first fan module 410 and the second fan module 420 are preferred to be the fan module 220 in FIG. 2. The first module RC circuit 402 receives and delays a module control signal MFAN_ID for a period of first module time mt1 to output a first module delay control signal MDFAN_ID1 for controlling the first fan module 410. The second module RC circuit 404 receives and delays the module control signal MFAN_ID for a period of second module time mt2 to output a second module delay control signal MDFAN_ID2 for controlling the second fan module 420. The first module time t1 is not equal to the second module time mt2, so the first fan module 410 and the second fan module 420 respectively receive the first module delay control signal MDFAN_ID1 and the second module delay control signal MDFAN_ID2 at different time. Therefore, the first module surge current in the first fan module 410 and the second module surge current in the second fan module 420 are not generated at the same time.

According to the spirit of the invention, the first module RC circuit 402 and the second module RC circuit 404 have respectively different time constant α, which can give rise to different delay time mt1 and mt2. The first module RC circuit 402 has a third switch, a fifth capacitor C5, a sixth capacitor C6 and a third impedance R3. The third switch Q3 has a third switch control terminal, a first terminal, and a second terminal. For example, the third switch is a N-channel MOSFET Q3, the third switch control terminal is the gate G3 of the transistor Q3, the first terminal of the third switch is the drain D3 of the transistor Q3, and the second terminal of the third switch is the source S3 of the transistor Q3. The gate G3 is for receiving the control signal MFAN_ID while the source S3 is coupled to a constant voltage, such as the ground voltage. The third impedance R3 has one terminal coupled to a voltage source VCC and the other terminal coupled to the third node N3, which is coupled to the drain D3 via the fifth capacitor C5. The sixth capacitor C6 has one terminal coupled to the third node N3 and the other terminal coupled to the ground voltage. The first module RC circuit 402 outputs a first delay control signal MDFAN_ID1 at the third node N3. When the module control signal MFAN_ID is inputted to the first module RC circuit 402, the third switch Q3 is turned on and the first module delay control signal MDFAN_ID1 is generated at the third node N3 after a period of first module time mt2 according to the parameters R3, C5, and C6.

The second module RC circuit 404 has the same circuit structure with the first module RC circuit 402 except for the different values of impedance R and capacitor C. The second module RC circuit 404 includes a fourth switch, a seventh capacitor C7, an eighth capacitor C8 and a fourth impedance R4. The fourth switch is such as a N-channel MOSFET Q4. Since the second module RC circuit 404 has the same circuit structure with the first module RC circuit 402, any detail of the second RC circuit is unnecessarily given here. Similarly, When the module control signal MFAN_ID is inputted to the second module RC circuit 404, the fourth switch Q4 is turned on and the second delay control signal DFAN_ID2 is generated at the fourth node N4 after a period of second time mt2 according to the parameters R4, C7, and C8.

The apparatus of controlling surge current in a fan module disclosed by the embodiment uses simple RC circuits providing different time constants to generate the first surge current in the first fan motor and the second surge current in the second fan motor at different time. The apparatus of controlling surge current in several fan modules according to another embodiment also uses the first and the second module RC circuits providing different time constants to generate the first surge current in the first fan module 410 and the second surge current in the second fan module 420 at different time.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An apparatus of controlling surge current in a fan module, applied in a blade server, the blade server comprising the fan module, the fan module comprising a first fan motor and a second fan motor, the blade server generating a control signal, the apparatus comprising:
a first delay device, for receiving and delaying the control signal for a period of first time to output a first delay control signal;
a first driver, for receiving the first delay control signal to drive the first fan motor;
a second delay device, for receiving and delaying the control signal for a period of second time to output a second delay control signal; and
a second driver, for receiving the second delay control signal to drive the second fan motor;
where the first time is not equal to the second time, the first fan motor and the second fan motor respectively receive the first delay control signal and the second delay control signal at different time, and thus a first surge current in the first fan motor and a second surge current in the second fan motor are not generated at the same time.

2. The apparatus according to claim 1, wherein the first delay device comprises a first resistor/capacitor (RC) circuit.

3. The apparatus according to claim 2, wherein the second delay device comprises a second RC circuit.

4. The apparatus according to claim 3, wherein the first RC circuit and the second RC circuit have different time constants.

5. The apparatus according to claim 1, wherein the first delay device and the second delay device are respectively a first resistor/capacitor (RC) circuit and a second RC circuit, and the first RC circuit has a different time constant from the second RC circuit.

6. The apparatus according to claim 5, wherein the first RC circuit comprises a first switch, a first capacitor, a second capacitor and a first impedance, the first switch has a first switch control terminal, a first terminal and a second terminal, the first control terminal receives the control signal, the first terminal of the first switch is coupled to a constant voltage, one terminal of the first impedance is coupled to a voltage source, and the other terminal of the first impedance is coupled to the first terminal of the first switch and coupled to the constant voltage via the second capacitor.

7. The apparatus according to claim 6, wherein the first RC circuit outputs the first delay control signal at the terminal coupling the first capacitor and the second capacitor.

8. The apparatus according to claim 7, wherein the second RC circuit comprises a second switch, a third capacitor, a fourth capacitor and a second impedance, the second switch has a second switch control terminal, a first terminal and a second terminal, the second switch control terminal receives the control signal, the second terminal of the second switch is coupled to a constant voltage, one terminal of the second impedance is coupled to the voltage source, and the other terminal of the second impedance is coupled to the first terminal of the second switch via the third capacitor and coupled to the constant voltage via the fourth capacitor.

9. The apparatus according to claim 8, wherein the second RC circuit outputs the second delay control signal at the terminal coupling the third capacitor and the fourth capacitor.

10. A blade server, comprising:
a first fan module and a second fan module;
a first module resistor/capacitor (RC) circuit, for receiving and delaying a module control signal for a period of first module time to output a first module delay control signal for controlling the first fan module; and
a second module RC circuit, for receiving and delaying the module control signal for a period of second module time to output a second module delay control signal for controlling the second fan module;
wherein the first module time is not equal to the second module time, the first fan module and the second fan module respectively receive the first module delay control signal and the second module delay control signal at different time, and thus a first module surge current in the first fan module and a second module surge current in the second fan module are not generated at the same time.

11. The blade server according to claim 10, wherein the first module RC circuit comprises a third switch, a fifth capacitor, a sixth capacitor and a third impedance, the third switch has a third switch control terminal, a first terminal and a second terminal, the third switch control terminal receives the module control signal, the second terminal of the third switch is coupled to a constant voltage, one terminal of the third impedance is coupled to a voltage source, and the other terminal of the third impedance is coupled to the first terminal of the third switch via the fifth capacitor and coupled to the constant voltage via the sixth capacitor wherein the first module delay control signal is output at the terminal coupling the fifth capacitor and the sixth capacitor.

12. The blade server according to claim 11, wherein the second module RC circuit comprises a fourth switch, a seventh capacitor, an eighth capacitor and a fourth impedance, the fourth switch has a fourth switch control terminal, a first terminal and a second terminal, the fourth switch control terminal receives the module control signal, the second terminal of the fourth switch is coupled to a constant voltage, one terminal of the fourth impedance is coupled to a voltage source, and the other terminal of the fourth impedance is coupled to the first terminal of the fourth switch via the seventh capacitor and coupled to the constant voltage via the eighth capacitor wherein the second module delay control signal is output at the terminal coupling the seventh capacitor and the eighth capacitor.

13. The blade server according to claim 12, wherein the first module RC circuit and the second module RC circuit have different time constants.

14. A method of controlling surge current in a fan module, applied in a blade server, the blade server generating a control signal, the method comprising:
providing a fan module, comprising a first fan motor, a second fan motor, a first resistor/capacitor (RC) circuit and a second RC circuit;
receiving and delaying the control signal for a period of first time by the first RC circuit to generate a first delay control signal for driving the first fan motor; and
receiving and delaying the control signal for a period of second time by the second RC circuit to generate a second delay control signal for driving the second fan motor;
wherein the first time is not equal to the second time, and thus a first surge current in the first fan motor and a second surge current in the second fan motor are not generated at the same time.

15. The method according to claim 14, wherein the first RC circuit and the second RC circuit have respectively different values of a resistor and a capacitor for providing the first time and the second time.

16. A method of controlling surge current in a plurality of fan modules, applied in a blade server, the fan modules comprising a first fan module and a second module, the blade server comprising the fan modules, the blade server outputting a module control signal, the method comprising:
receiving and delaying the module control signal for a period of first module time to output a first module delay control signal for driving the first fan motor; and
receiving and delaying the control signal for a period of second module time to output a second module delay control signal for driving the second fan motor;
wherein the first module time is not equal to the second module time, and thus a first surge current in the first fan motor and a second surge current in the second fan motor are not generated at the same time.

17. The method according to claim 16, wherein the first module delay control signal is output by a first module resistor/capacitor (RC) circuit, the second module delay control signal is output by a second module RC circuit, and the first module RC circuit and the second module RC circuit have respectively different values of a resistor and a capacitor.

18. The method according to claim 17, wherein the first module RC circuit and the second module RC circuit respectively provide the first module time and the second module time according to the different values of the resistor and the capacitor.
